(19) United States
(12) Patent Application Publication
(10) Pub. No.: US 2007/0076171 A1
(43) Pub. Date: Apr. 5, 2007

(54) Wobulator position sensing system and method

(76) Inventors: Donald J. Fasen, Boise, ID (US); Anurag Gupta, Corvallis, OR (US); Michael D. Long, Portland, OR (US); Matthew Smith, Albany, OR (US); Christopher Neel, Ann Arbor, MI (US); Douglas A. Pederson, Corvallis, OR (US)

Correspondence Address: HEWLETT-PACKARD COMPANY;Intellectual Property Administration, P.O. Box 272400, Fort Collins, CO, 80527-2400, US

(21) Appl. No.: 11/231,206

(22) Filed: Sep. 20, 2005

(51) Int. Cl. G03B 21/26

(52) U.S. Cl. 353/30

(57) ABSTRACT

A wobulator position sensing system includes a wobulator plate, having a wobulator window, and a position detector, associated with the wobulator plate. The wobulator is disposed along an image projection path, and configured to selectively tilt so as to shift the projection path. The position detector is configured to sense a magnitude of tilting of the wobulator plate, and to produce a feedback signal useable to control tilting of the wobulator plate.

### BACKGROUND

In the field of image projection systems, it has been found that the perceived resolution of an image can be increased by subdividing each image frame into multiple image sub-frames, and shifting each sub-frame slightly (e.g. half the width of a pixel) with respect to the other(s) to blur the edges of pixels in the final image frame. This shifting can be about one or two axes, and can go any direction from a base or standard image projection position. Shifting of the image in this way allows the appearance of higher resolution without increasing the pixel density in the projection system, and thus without significant cost increase.

In one type of projection system having this sort of image shifting capability, the image shifting is done with a wobulator or wobulation device. A mechanical wobulation device can be essentially a plate, such as a transparent plate (e.g. of glass) or a reflective plate (e.g. a mirror), to which the image is projected, and which continuously oscillates or tilts back and forth at some multiple of the base refresh rate of the projection system. This tilting causes a corresponding shift in the projection path of each sub-frame image, such that adjacent pixel edges in the final image frame appear to overlap and thus provide the appearance of a higher resolution image.

Oscillation of the wobulation device can be provided in many ways, some of which have higher accuracy than others. One relatively simple and economical configuration employs one or more motors, such as voice coil motors, similar to those used in conventional audio speakers. The wobulation device is mounted on one or more pivots, and the motors provide the oscillating force to move the wobulator window. Voice coil motors are inexpensive and readily available. However, it is desirable to have accurate control of the motion provided by these motors, so that the degree of image shifting can be accurately controlled.

Additionally, the precision of placement of components within a projection system can affect the accuracy of sensing of the position (and degree of tilt) of the wobulation device. However, ensuring extremely high accuracy in placement of internal projector components can introduce additional cost and complexity to the system.

### BRIEF DESCRIPTION OF THE DRAWINGS

Various features and advantages of the invention will be apparent from the detailed description which follows, taken in conjunction with the accompanying drawings, which together illustrate, by way of example, features of the invention, and wherein:

FIG. 1 is a front view of an embodiment of a wobulation system;

FIG. 2 is an edge view of the wobulation system depicted in FIG. 1;

FIG. 3 is a schematic illustration of a group of pixels shifted by a wobulation system;

FIG. 4 is a schematic view of one embodiment of a refractive wobulation device;

FIG. 5 is a schematic view of one embodiment of a reflective wobulation device;

FIGS. 6A and 6B are schematic diagrams of a refractive wobulation device having a refractive optical wobulator position sensing system;

FIGS. 7A and 7B are schematic diagrams of a refractive wobulation device having a reflective optical wobulator position sensing system;

FIG. 8A is a schematic illustration of the effect of varying sense beam position in the reflective optical wobulator position sensing system;

FIG. 8B is a schematic illustration of the effect of varying sense beam angle in the reflective optical wobulator position sensing system;

FIG. 9 is a schematic diagram of a reflective optical wobulation device having a reflective wobulator position sensing system;

FIG. 10 is a schematic diagram of one embodiment of a photodetector and associated circuitry for use with an optical wobulator position sensing system;

FIG. 11 is a front view of one embodiment of a wobulation device having a capacitive wobulator position sensing system;

FIG. 12 is an edge view of the wobulator system of FIG. 11;

FIG. 13 is a graph of capacitance relative to the angle of the wobulator plate for the capacitive wobulator position sensing system of FIG. 11;

FIG. 14 is a schematic diagram of one embodiment of the circuitry for detecting the wobulator position using a capacitive wobulator position sensing system;

FIG. 15 is a front view of another embodiment of a wobulation device having a capacitive wobulator position sensing system;

FIG. 16 is an edge view of the wobulation device of FIG. 15;

FIG. 17 is a close-up edge view of a capacitor assembly of the wobulation device of FIG. 15, showing the range of positions of the dielectric arm between the capacitor plates;

FIG. 18a is an end view of the capacitor assembly of FIG. 17, showing the range of positions of the dielectric arm between the capacitor plates for one-axis wobulation;

FIG. 18b is an end view of the capacitor assembly of FIG. 17, showing the effect on the angle of the dielectric arm between the capacitor plates during two-axis wobulation;

FIG. 19 is a front view of one embodiment of a wobulation device having a Hall Effect wobulator position sensing system;

FIG. 20 is an edge view of the wobulator system of FIG. 19;

FIG. 21 is a detail view of a Hall Effect sensor and magnets of the Hall Effect wobulator position sensing system of FIG. 19; and

FIG. 22 is a graph of relative magnetic flux density and relative output voltage versus the position of the Hall Effect sensor relative to the magnets of the Hall Effect wobulator position sensing system.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

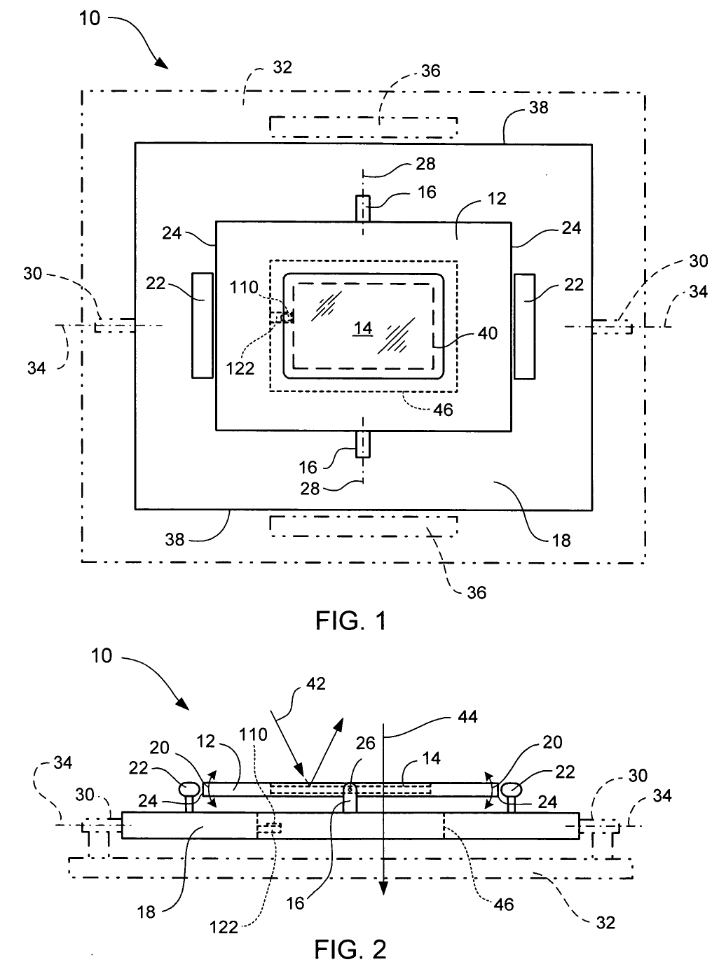

One embodiment of a mechanical wobulator or wobulation system is shown in FIGS. 1 and 2. As used herein, the term “wobulator” refers to any device that shifts the path of a projected image, so that pixel edges in sub-frames of the image overlap and blur together, giving the appearance of a higher resolution image. The term “wobulation” refers to the effect or use of a wobulator. The wobulation system 10 generally includes a wobulator plate 12 having a wobulator window 14 generally centrally located therein. The wobulator plate is mounted via pivots 16 upon a base or mount 18, and is configured to oscillate or tilt back and forth upon the pivots, in the direction of arrows 20 in FIG. 2. A pair of electromagnetic coils 22 are located adjacent to the opposite free edges 24 of the wobulator plate, and comprise a driving motor for causing the tilting motion of the wobulator plate. The coils 22 for tilting the wobulator plate 12 can be part of a floating motor, such as a voice coil motor, as is frequently used in audio speaker systems. The wobulator plate 12 (and therefore the wobulator window 14) thus tilt about a first wobulation axis passing through the pivot points 26 of the pivots, represented by center lines 28. This tilting axis is generally in the plane of the wobulator plate, and can pass approximately through the center of the wobulator window, as shown, though this is not required.

The wobulation device 10 can be configured for multiple axis wobulation, one configuration for which is shown in phantom lines in FIGS. 1 and 2. To allow the wobulator plate to pivot about more than one axis, the wobulator base 18 can be pivotally mounted upon a second set of pivots 30 upon a second base 32. In the configuration shown, the second tilting axis 34 of the second set of pivots is generally in the plane of the wobulator base, and is substantially perpendicular to the tilting axis 28 of the first set of pivots. This configuration thus allows the wobulator window to pivot about two orthogonal axes. In this embodiment, additional driving coils 36 are disposed adjacent to the opposing free edges 38 of the wobulator base to provide a driving motor for the second axis wobulation.

Other mechanical configurations for providing multiple-axis wobulation can also be used. While the following discussion is presented in terms of one-axis wobulation, the principles and embodiments shown are equally applicable to two-axis wobulation.

The wobulator device 10 is positioned so that the wobulator window 14 is in the path of a projected video image beam, the image beam striking an image region 40 of the wobulator window. As used herein, the term “wobulator window” is intended to encompass substantially transparent windows (e.g. glass) through which the image beam passes, and reflective wobulator windows (e.g. a mirror), which reflect the image beam. That is, the embodiment shown in FIG. 2 can be configured with a reflective wobulator window that causes the image beam to be reflected, as indicated by arrow 42, or with a transmissive wobulator window that allows the image beam to pass through, as indicated by arrow 44. It will be apparent that where a transmissive wobulator window is used, the wobulator base 18 will require a window or cutout 46 (shown in dashed lines in FIGS. 1 and 2) for allowing passage of the image beam.

Wobulation devices that include a transmissive wobulator window operate by refracting the image beam. Shown in FIG. 4 is a schematic depiction of a projection system 50 having a refractive wobulation device. The projection system generally includes a spatial light modulator 52, which projects a video image along an initial projection path 54 toward a substantially transparent wobulator window 14a. The wobulator window is shown on edge in this view, its thickness and size being greatly exaggerated for illustrative purposes. The spatial light modulator can be any of a variety of projection systems, such as digital mirror devices (DMD), LCD projectors, etc. The image passes through the wobulator window, then through projection optics 58, and thence along a final projection path 60 to a projection surface (e.g. a screen) 62.

The transmissive wobulator window 14a can be of glass or other suitable material for passing a video image. Typical wobulator windows are in the range of 1 to 2 millimeters thick, and can vary in size and shape. Rectangular wobulator windows of about 35 mm×40 mm have been used, as have circular wobulator windows of about 25 mm in diameter. The wobulator window has a refractive property—that is, an index of refraction. The wobulator window has a neutral position, designated at 56 and shown in solid lines in FIG. 4. In this position the window is normal to the image beam, and thus its presence has little or no effect on the image (e.g. no refraction). Accordingly, when the wobulator window is in the neutral position the projection path is undisturbed, so that the initial and final projection paths 54, 60, are substantially collinear, unless altered by any effects of the projection optics 58.

As noted above, the wobulator window 14a is configured to continuously oscillate or tilt back and forth, as indicated by arrow 64. In the view of FIG. 4, the oscillation is about an axis that extends through the middle of the window and is perpendicular to the plane of the drawing. When the wobulator window moves to a tilted position 18′ (indicated by dashed lines), the projection path is affected by the refractive properties of the window, and is shifted, thus providing a shifted final projection path 22′ (indicated by dashed lines).

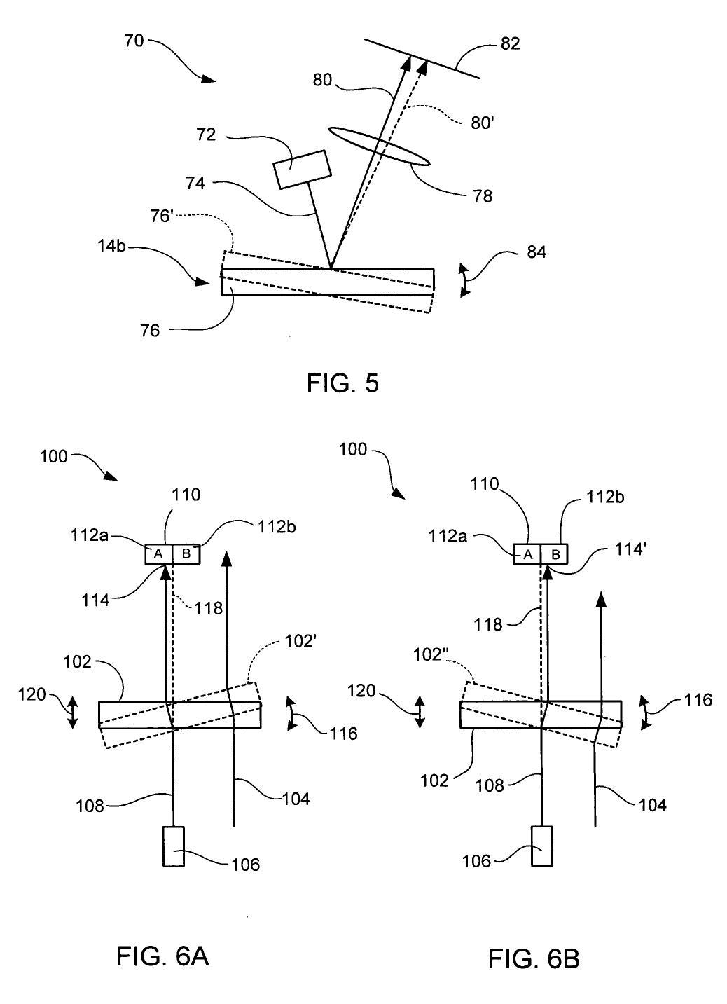

Another projection system 70 having a reflective wobulator window 14b is depicted in FIG. 5. Like the refractive system shown in FIG. 4, this projection system includes a spatial light modulator 72, which projects a video image along an initial projection path 74 toward the wobulator window. In this embodiment, the wobulator window is a mirror. When the wobulator window is in a neutral position, as depicted at 76 (in solid lines in FIG. 5), the image passes through projection optics 78 after reflection from the mirror, and thence along a final projection path 80 to a screen or other projection surface 82. However, when the wobulator window tilts, as indicated by arrow 84, to the tilted position 76′ (shown in dashed lines), the final projection path is shifted to a shifted final projection path 80′ (indicated in dashed lines).

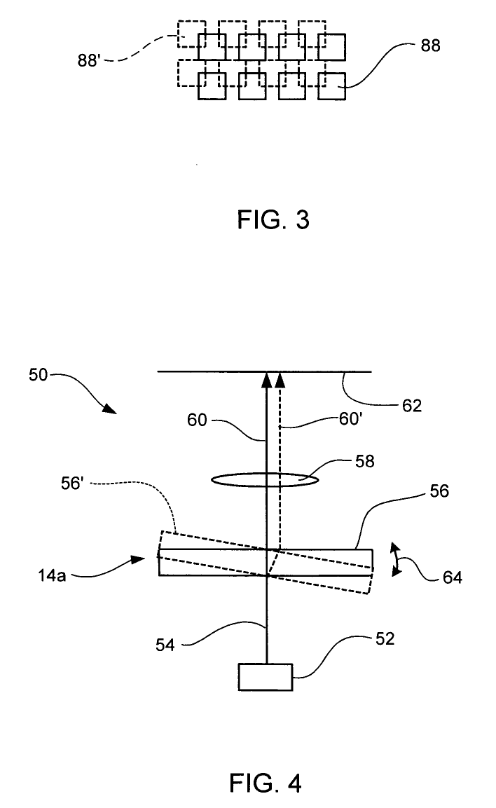

The effect of the wobulator device—whether reflective or refractive—upon an image beam is illustrated in FIG. 3. This figure shows a group of pixels to illustrate the effect of shifting the image as described above. The group of pixels 88, shown in solid lines, represent a portion of an image when at a default projection location. This is the pixel location when the wobulator window is at the neutral position. However, when the wobulator window tilts in one or more degrees of freedom, the position of the group of pixels is shifted to a shifted position, represented by the pixel group 88′ (in dashed lines).

The shifted pixel group 88′ shown in FIG. 3 is shifted upward and to the left of the default pixel location. This sort of shift can be produced by two-axis wobulation, or it can be provided by a single-axis wobulator device that is oriented with its pivoting axis oriented at some angle (e.g. 45°) with respect to the alignment of rows and columns of pixels. The wobulation device is configured to provide a shift that is less than the maximum dimension of a pixel, and in some embodiments is about ¼ of a pixel. When thus shifted, adjacent pixel edges in the final image frame run together and provide a higher resolution image. That is, the edges of adjacent pixels are caused to overlap, so that the pixel density appears higher.

Wobulation can be used to increase the apparent resolution of a static image, or of a video image that is made up of a temporal series of images or frames, each frame being projected for an image frame period. Each shifted image position corresponds to one temporal subdivision or sub-frame of the image frame period. Accordingly, in a video projection system, the wobulator window oscillates at a rate that is a multiple of the standard image refresh rate, depending upon the number of image sub-frames per frame period. For example, if the standard image refresh rate is 60 Hz, and the wobulation device is configured to provide two image positions, the wobulator window will oscillate at 120 Hz to shift each of two sub-frames to its proper position. If there are a greater number of sub-frames, the wobulator will be configured to shift to multiple positions at a higher rate. Because of the very rapid projection of the slightly offset images, the effect is to blur the edges of pixels, and thus provide the appearance of a higher resolution image.

It will be apparent that FIGS. 4 and 5 are greatly exaggerated and simplified for purposes of illustration. The magnitude of shifting provided by a wobulation device is very small. For example, the amount of image beam displacement required to shift the image ±0.25 pixels is about ±5 μm. Accordingly, the actual angular tilt of the wobulator window is correspondingly small. Additionally, while all but FIGS. 1 and 2 depict oscillation of the wobulator about a single axis, it will be apparent that wobulation devices that oscillate about two axes can also be provided. Additionally, given that refraction and reflection are a function of the angle of incidence of light upon a surface, and are not affected by proximity, it will be apparent that the axis of oscillation need not be in the center of the wobulator window, but can be at an edge, etc.

Unfortunately, the level of precision of motion of the floating coil motors that move the wobulator window may be lower than that needed for precise control of motion of the wobulator window. To achieve an accurate and stable image shift between two or more desired image positions, a position sensing scheme which accurately indicates the image beam position is desired. That is, it is helpful to determine the actual tilt (e.g. ½° versus 1°) of the wobulator window. This information can then be fed back into the wobulator driving circuitry so as to allow adjustment of its motion.

However, the wobulator plate moves very rapidly by a very small amount, and it is difficult to measure small displacements quickly. Nevertheless a suitable wobulator position sensor should be able to do so with a high degree of accuracy. At the same time, it is desirable that the wobulator position sensor be as inexpensive as possible. Additionally, the measurement environment has variable temperature, and can have uncontrolled magnetic, electrical, and visible/IR/UV light noise. It is also desirable that a wobulator position sensing and feedback system be accurate, robust, and relatively tolerant of variations in component position. There are many types of sensing systems for sensing positions of mechanical devices. However, many of these systems require high precision components and highly accurate placement of the components with respect to the object of measurement.

The inventors have developed various embodiments of optical and electrical wobulator position sensing systems that are accurate and very tolerant of component placement position and other variables within a projection system. The systems and their associated methods are configured to be relatively insensitive to the position of the wobulator window measured along the axis of the image beam, so that expected static and dynamic shifts in the position of the window along this axis do not affect the accuracy of the position sensing system.

Depicted in FIGS. 6A and 6B are schematic diagrams of a refractive wobulation device 100 having a refractive optical wobulator position sensing system. This wobulation system is like that depicted in FIG. 4, though all of the elements of the entire projection system are not shown. FIG. 6A depicts the wobulator window 102 tilted counterclockwise to a first tilted position 102′ (shown in dashed lines), and FIG. 6B shows the wobulator window tilted clockwise to a second tilted position 102″ (shown in dashed lines). With the wobulator window tilted, the path of the image beam 104 is deflected due to refraction, as described above.

The optical wobulator position sensing system includes a light source 106 that is configured to produce a beam of light 108. This beam is a sense beam, and is aimed at a portion of the wobulator window 102. So as not to interfere with the projection of the image, the sense beam can be aimed at a region of the wobulator window that is outside the image beam. For example, as shown in FIG. 1, the wobulator window 14 can be physically larger than the image region 40, with the sense beam passing through an edge region of the wobulator window outside the image region.

A variety of types of light sources can be used. In certain embodiments it is desirable that the light beam be a collimated beam. One type of light source that can be used is an LED device with a collimating lens. Another suitable type of light source is a laser, such as a diode laser with suitable collimating optics. A laser will naturally produce far brighter light output (greater power per unit area per unit solid angle). As a result, a lower power laser can be used in place of a higher power LED for the same net light output.

The light source can be selected to provide a sense beam that is either inside or outside the visible spectrum. The inventors have used both visible red and infrared light sources for the sense beam. The relatively longer wavelength of light in the red and infrared range is generally more compatible with the sensitivity range of photodetectors. For example, a sense beam having a wavelength in the range of 900 nm has been used. Additional discussion of the allowable range of the sense beam wavelength is provided below. Infrared LED and laser devices that are suitable for this system are commercially available.

A photodetector 110 is positioned and configured to receive the sense beam 108 after contact with the wobulator window 102. In this case, the photodetector is disposed on the opposite side of the window from the sense beam source 106, and receives the sense beam after it passes through the wobulator window 102. One configuration for placing a photodetector in this manner is depicted in FIG. 1. The photodetector can be mounted upon an arm or support 122 extending from a side of an image beam window or opening 46 in the wobulator base 18. This photodetector support can be oriented to extend into the path of the sense beam, yet remain outside the image region 40 of the wobulator window 14, so as not to obstruct the image.

Referring back to FIG. 6A, the photodetector 110 detects a shift of position of incidence 114 of the sense beam upon it due to tilt of the wobulation device. The photodetector shown in FIGS. 6A and 6B includes a pair of photodiodes 112a, 112b, which produce an electrical signal when contacted with light. Such photodiodes are widely available and are commonly used in a variety of detection systems. The photodiodes can be configured from a single silicon chip that is scribed down the middle to divide into A and B halves, or can be separate chips that are placed side by side. It will be apparent that a photodiode is only one type of photodetector. Other types of photodetectors can also be used. The photodetector is positioned so that when the wobulator is in the neutral position (with the wobulator window normal to the sense beam, as indicated at 102) the centroid of the undeflected sense beam 118 (dashed line) is aligned with the dividing line between the two portions of the photodetector.

Matching the wavelength of the sense beam to the photodetector is desirable. This generally involves selecting a photodetector that has a high sensitivity at the wavelength of the sense beam. However, deviating from the actual peak of sensitivity of the sensor can help provide better signal noise characteristics in some cases. For example, if the photodetector has a peak sensitivity at 940 nm, it can nevertheless provide a strong signal with less noise from a light source having a wavelength of 900 nm. Those skilled in the art will be able to match the sense beam to the photodetector to obtain a desired position signal.

When the wobulator window 102 tilts to the left to position 102′, as indicated by arrow 116 in FIG. 6A, the sense beam 108 is deflected in the same manner as the image beam 104, and its point of contact 114 on the photodetector 110 also moves to the left into the “A” region 112a. However, when the wobulator window tilts to the right to position 102″, as indicated by arrow 116 in FIG. 6B, the sense beam is again deflected in the same manner as the image beam, and its point of contact 114′ on the photodetector moves to the right, into the “B” region 112b.

Notwithstanding this movement, because the sense beam 108 has a thickness and the actual shift provided by the wobulator window 102 is quite small in magnitude, a portion of the sense beam will still contact the “A” region 112a when deflected right, and vice versa. Consequently, a signal value P representing the relative position of contact 114 of the sense beam upon the photodetector 110 can be determined by measuring the differential signal produced by each portion of the photodiode according to the following formula:
P=(A−B)/(A+B)
wherein A represents the output voltage of the “A” region, and B represents the output voltage of the “B” region. This positional information can be provided back to the wobulator driving circuitry (150 in FIG. 8), and also to the image processing systems of the projector (not shown), to allow real-time detection and control of the wobulator position in synchronization with the sub-frame image generation.

The refractive wobulator position sensing system 100 depicted in FIGS. 6A and 6B is accurate and robust. By sensing the shift of the image beam 104 with a sense beam 108 that passes through the same window 102 as the image beam, the effects of the refractive beam shift will match for both beams. This can eliminate many error sources in the detection of the beam shift, allowing greater accuracy in the image beam shift. Moreover, with this system the effects of parameter variations (e.g. variation of the index of refraction of the wobulator window, etc.) on the indicated beam position relative to the true image beam position are reduced.

Additionally, a less precise mechanical setup for the wobulator window can be tolerated without degrading image shift accuracy. For example, because refraction is not affected by proximity, but only by angle of incidence, the relative separation between the sense beam light source, the photodetector, and the wobulator window has little or no effect. Specifically, if the position of the wobulator window 102 relative to the light source 106 varies laterally (in the direction indicated by arrow 120, parallel to the axis of the image beam 104), there will be no change in the operation of the wobulator position sensing system. Such positional variance could be caused by static manufacturing variations or dynamic shifting due to shock and vibration. Tolerance for static manufacturing variations can be desirable where the projection system components are mounted to relatively low precision assemblies, such as injection-molded plastic casings and the like.

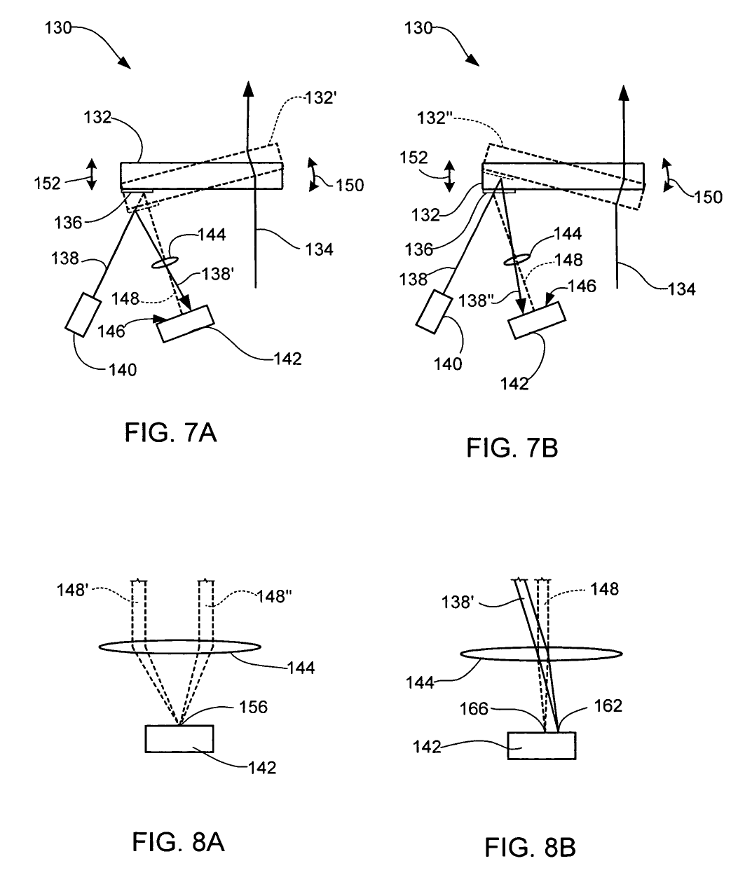

A refractive wobulation device as described above can also be configured with a reflective wobulator position sensing system 130, as shown in FIGS. 7A and 7B. As with the system depicted in FIGS. 6A and 6B, the majority of the wobulator window 132 is transparent. The image beam 134 passes through the transparent portion of the wobulator window, and its position is shifted by refraction, depending upon the relative tilt of the window 132. However, the wobulator window also includes a reflective portion 136 (e.g. a small mirrored portion outside the image beam region) that is configured to reflect the sense beam 138. Accordingly, the sense beam light source 140 is disposed on one side of the wobulator window and aimed at the reflective portion. The photodetector 142 is also disposed on the same side of the window, and receives the reflected sense beam after its contact with the window. A collection lens 144 is disposed adjacent to the photodetector, and is positioned to receive and focus the sense beam upon the surface 146 of the photodetector. It will be apparent that the thickness of the reflective portion is greatly exaggerated in this view. Additionally, given that the wobulator window is naturally quite reflective, the reflective portion can simply comprise a region of the wobulator window that is highly polished or provided with a thin reflective coating.

The photodetector 142 is positioned such that when the wobulator window 132 is in the neutral position, the sense beam 138 will strike in the center of the photodetector, as indicated by the undeflected sense beam 148 (in dashed lines). When the wobulator tilts to the left to position 132′ in FIG. 7A, providing a leftward shift in the image beam 134, the sense beam shifts to a first shifted sense beam path 138′ and projects toward the right side of the photodetector. When the wobulator tilts to the right to position 132″ in FIG. 7B, providing a rightward shift in the image beam, the sense beam shifts to a second shifted sense beam path 138″ and projects toward the left side of the photodetector.

The collection lens 144 makes the reflective wobulator position sensing system 130 substantially insensitive to lateral changes (in the direction of arrow 152) in the position of the wobulator window 132 and reflective portion 136. This aspect of the system is illustrated in FIGS. 8A and 8B. As shown in FIG. 8A, when an undeflected sense beam 148′ passes through the collection lens toward one side of the lens, it will be focused to the same spot 156 on the photodetector 142 as it would have if that same beam were laterally translated to pass through another part of the lens, but otherwise had the same angle relative to the lens, as indicated by the parallel undeflected sense beam 148″. In other words, the lateral position at which the sense beam contacts the lens does not affect its position of contact on the photodetector.

However, tilt of the wobulator window and hence a change in the angle of incidence of the sense beam upon the lens does affect the location where the sense beam will strike the photodetector, as shown in FIG. 8B. A first undeflected sense beam 148 that contacts the collection lens at a first angle will contact the photodetector at a first position 162. However, a deflected sense beam 138′ that contacts the lens at a different angle will contact the photodetector at a different location 166.

Selecting a suitable collection lens 144 involves selecting a lens with a diameter large enough to cover any lateral positioning tolerance of the beam. The lens should have an F number (defined by focal length divided by the beam diameter) that is large enough to reduce the tolerance in the location of the focused spot on the detector along the axis defined by the center of the lens and the detector center. This tolerance can be expressed (in microns) as ±1.6×(F no.)². So long as the focusing lens 144 is large enough to encompass the total range of possible positions of the sense beam 138, lateral displacement or misposition of the wobulator window 132 will have little or no effect.

The photodetector 142 used in the embodiment of FIGS. 7A and 7B can be a two-part photodiode (60 in FIGS. 6A and 6B). Alternatively, a large single photodiode known as a lateral effect photodiode or position sensing diode (PSD) can be used. Such photodiodes are commercially available. For example, a suitable commercially available lateral effect photodiode that the inventor has used is selected from a group of possible sensors having a sensitivity across a relatively wide spectral range in the infrared region, from as low as 300 nm to as high as 1200 nm, with a peak sensitivity generally in the range of 800 to 1000 nm. For accurate position sensing, with the two-part photodiode depicted in FIGS. 6A and 6B it is desirable that the neutral position sense beam 118 be generally aligned with the dividing point between the A and B portions 112a, 112b of the diode.

The lateral effect photodiode, on the other hand, is a type of continuous sensor, and may not require the same level of accuracy in positioning because it provides a signal indicating the relative change in position of the sense beam throughout the whole region of its sensing surface. These types of sensors generally provide better signal-to-noise characteristics with a stronger beam of light. A schematic diagram of a lateral effect photodiode 180 and associated circuitry for use with a wobulation position sensing system is shown in FIG. 10. The lateral effect photodiode is a single semiconductor chip having electrodes 182a, 182b disposed at opposing ends. While this device is larger than the two-part photodiode described above, it is still quite small. One lateral effect photodiode that is commercially available and can be used in a wobulator position sensing system has a sensing surface that is about 1 mm wide by 2 mm long. While the lateral effect photodioide shown in FIG. 10 includes two electrodes for sensing positional variation in one dimension only (e.g. vertical displacement as shown in the figure), lateral effect photodioides that can detect positional variation in two dimensions (e.g. both vertical and horizontal displacement) are also available.

The light source 184 (e.g. an infrared LED or laser) provides a beam 186, which contacts the wobulator window 188. While FIG. 8 depicts the sense beam as passing through the wobulator window, this is intended to represent any type of contact of the sense beam with the wobulator window. The diagram of FIG. 10 applies to the system with either a reflective or refractive wobulator window. After contact with the wobulator window, the sense beam strikes the surface 190 of the lateral effect photodiode in a particular spot 192. This contact creates differential photo-induced currents 194a, 194b that are collected by each electrode 182a, 182b.

Each electrode 182a, 182b of the photodiode is connected to a pre amplifier 196a, 196b, which amplifies the respective signal, providing output signals V₁ and V₂ through lines 198 and 200. These signals are provided to the light driver 202 for the sense beam light source 184 (and provide the driving current for the light driver), and through to the position detector circuit 204. The position detector circuit is a difference amplifier that creates a position signal. A pair of AC coupling capacitors 206, 208 are provided to correct any signal offset, which may arise due to variations in manufacturing alignment, current, temperature and other effects. The AC coupling capacitors also filter out the DC component of the signal, which if not done could cause a shift in the position information. The AC coupling capacitors provide a high pass filter, and can have a time constant that is greater than 10 times the half-period of the wobulator window. Additionally, the drive power to the light driver is the sum of V1 and V2, so that the desired light power is maintained on the detector in spite of, for example, variations from part to part, temperature, or age of the LED.

The position detector circuit 204 provides a signal representing the wobulator position to the wobulator driver 210, thus giving immediate feedback on the wobulator position. In response to this position signal and wobulator driving signals received from other parts of the projection system (received through line 212), including the projector image processing system and a timing generator (not shown) the wobulator driver can directly adjust and accurately control the position of the wobulator 188 to provide accurate and consistent image shifting. In other words, this circuitry provides a feedback system between the photodetector and the wobulator driving circuit, and provides the wobulator driving circuit with a position signal corresponding to the tilt of the wobulator window. This allows rapid and accurate adjustment of tilting of the wobulator window in response to the position signal. It will be apparent that the lateral effect photodiode 180 and associated detection and feedback circuitry depicted in FIG. 10 can be used with any of the wobulator position sensing system embodiments disclosed herein. Likewise, the two part photodiode system (photodetector 110 in FIG. 6A) can also be used with this feedback circuit in any of the disclosed embodiments.

The reflective wobulator position sensing system 130 depicted in FIGS. 7A and 7B can provide greater sensitivity than the refractive wobulator sensing system shown in FIG. 6A because of the geometry of the reflection. Since the reflective system does not measure the beam shift due to refraction of the sense beam 138, some variations in parameters such as window thickness and index of refraction can introduce slight errors into the indicated beam position relative to the true beam position. That is, the sense beam may not experience the same changes as the image beam, and therefore may not be shifted exactly the same amount.

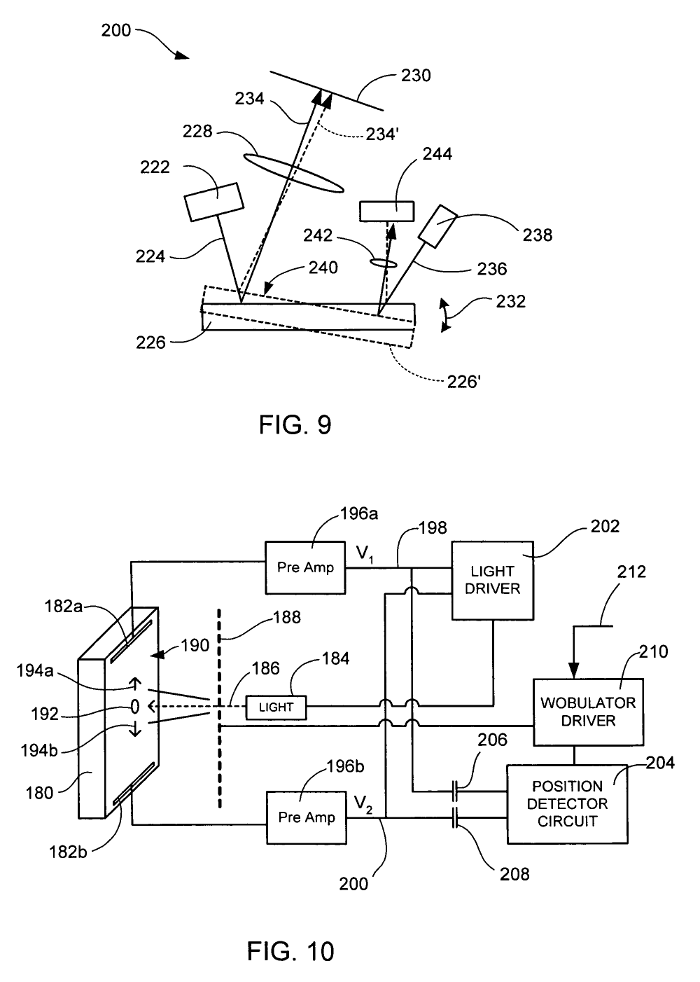

Another embodiment of a reflective wobulator sensing system 220 that may avoid some of these problems is shown in FIG. 9. This embodiment combines a reflective wobulator position sensing system with a reflective wobulation device. Like the system of FIG. 5, the reflective wobulation system includes a spatial light modulator 222, which projects a video image along an initial projection path 224 toward a reflective wobulator window 226 (e.g. a mirror). The image is reflected from the window, and passes through projection optics 228 and thence to a screen or other projection surface 230. When the wobulator window tilts in the direction indicated by arrow 232, to the tilted position 226′ (shown in dashed lines), the final projection path 234 is shifted to a shifted final projection path 234′ (indicated in dashed lines). While only one direction of tilt is shown in FIG. 9, it will be apparent that all of the tilting capabilities discussed above with respect to other embodiments, both as to direction and tilting about multiple axes, apply equally to this embodiment.

This embodiment of the wobulator position sensing system 220 is similar to that shown in FIGS. 7A and 7B, except that both the image beam 224/234 and sense beam 236 are reflected from the wobulator window 226. The sense beam proceeds from the light source 238, is reflected from the surface 240 of the wobulator window, passes through the collection lens 242, and strikes the photodetector 244. Since neither the sense beam nor the image beam are refracted in the embodiment of FIG. 9, this embodiment may not introduce errors due to variations in window thickness and index of refraction. Instead, both the sense beam and the image beam experience the very same angular shift due to reflection, which can enhance accuracy of detection. Additionally, unlike the embodiment of FIGS. 7A and 7B, the wobulator window has an entirely reflective surface, rather than having only a small mirrored portion (86 in FIG. 7A) disposed on an otherwise transparent window. This aspect can contribute to greater consistency in the quality of the reflective surface.

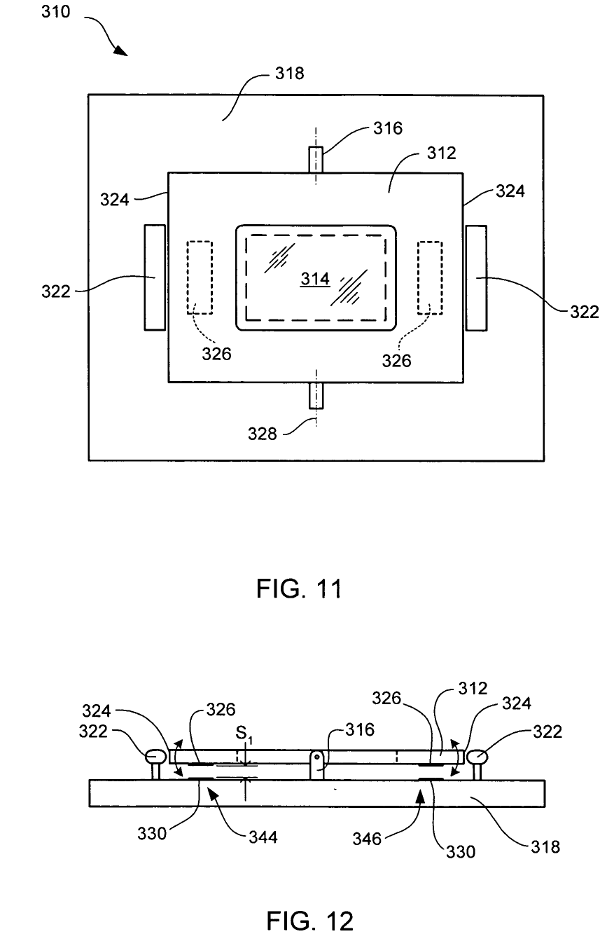

The wobulator position sensing system embodiments described above use electro-optical systems for detecting the wobulator position. However, other electronic wobulator position sensing configurations can also be used. Shown in FIGS. 11 and 12 is one embodiment of a capacitive wobulator position sensing system 310. As with other embodiments, this wobulator system includes a wobulator plate 312 having a wobulator window 314, the wobulator plate being pivotally connected to a wobulator base 318 via pivots 316. Motor coils 322 are disposed adjacent to the free edges 324 of the wobulator plate to provide a driving motor for the wobulator plate.

In this embodiment, capacitor plates 326 (e.g. metal plates) are mounted on the wobulator plate 312 on either side of the wobulator window 314 toward the free edges 324 of the wobulator plate and approximately equidistant from the pivoting axis 328. Corresponding opposing capacitor plates 330 are also placed on the wobulator mount 318, thus forming two capacitors 344, 346, whose plate distance or spacing S (and corresponding capacitance) will change as the wobulator plate tilts. It will be apparent that this capacitive sensing system is also adaptable to a two-axis wobulation system, like that shown in FIGS. 1 and 2. With reference to these figures, a two-axis capacitive wobulator position sensing system will include an additional aligned pair of capacitor plates (not shown) disposed upon the wobulator base 18 and second base 32, respectively.

Returning to FIGS. 11 and 12, the capacitors 344 and 346 are disposed on opposite sides of the pivot axis 328. Accordingly, their change in capacitance as the wobulator plate 312 tilts will be opposite in magnitude. That is, the capacitance of one capacitor will increase as that of the other decreases, and vice versa. Additionally, with the capacitors placed approximately equidistant from the pivot point, the range of variation of capacitance will be approximately the same for each capacitor because the range of change in spacing will be about the same. By detecting the difference in capacitance between the two capacitors, the magnitude and direction of wobulator tilt can be measured independently of the distance of the wobulator plate from the base or mount 318. The rotation of the wobulator plate can thus provide an analog feedback of wobulator position information to the wobulator driver circuit (210 in FIG. 10), creating a closed-loop control system.

The capacitive wobulator position sensing system 310 thus includes two capacitors mounted upon the wobulator plate and the wobulator base. The same type of system can be configured for 2-axis wobulation simply by providing four capacitors in a similar manner. The distance or spacing between the capacitor plates will change as the wobulator plate tilts, creating a change in capacitance in each capacitor, one increasing as the other decreases. The movement of the wobulator plate will change the capacitor plate spacing “S₁”, and will thus change capacitance, which can be calculated according to the following equation:
C=(8.854E−12*K*A)/S
Where:

C=Capacitance

K=Dielectric Constant (1.0 for air)

A=Surface Area of capacitor plates

S=Spacing of Capacitor plates (S₁ in the configuration of FIG. 11)

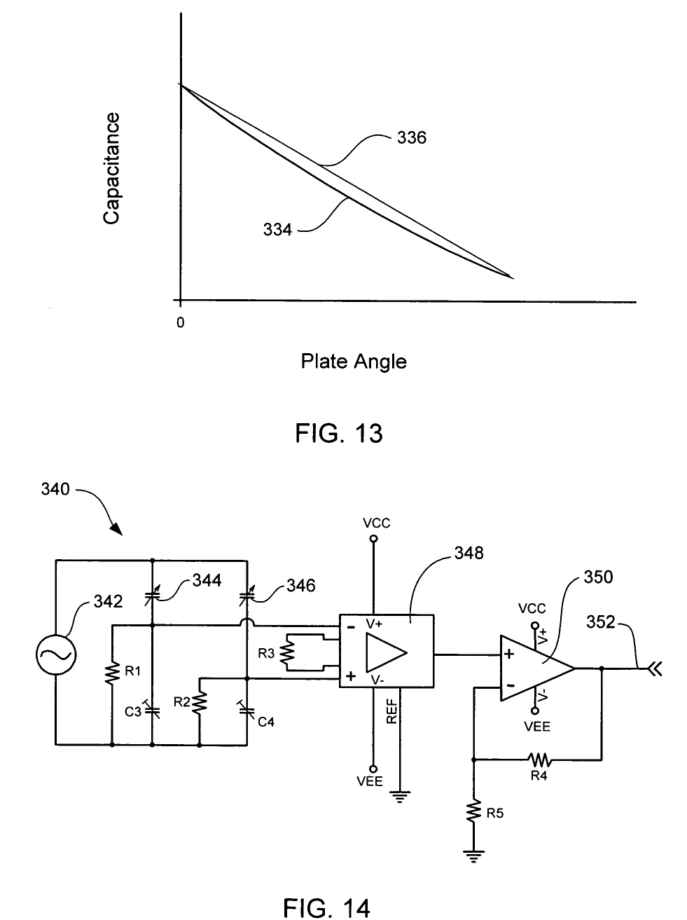

As the plate spacing decreases (plates closer together), the capacitance increases. As the plate spacing increases (plates farther apart), the capacitance decreases. A graph showing the change in capacitance with change in wobulator plate angle for one experimental embodiment of the capacitive wobulator position sensor system is provided in FIG. 13. As is apparent from this figure, the curve 334 representing change in capacitance with change in wobulator plate angle almost follows a straight line 336 between the maximum and minimum values.

Adding the capacitive wobulator position detection hardware to a wobulator system basically requires creating two capacitors (or four capacitors for 2-axis wobulation) and providing connecting wires. Each capacitor is created by its two aligned plates, with one plate on the underside of the wobulator plate, and a corresponding capacitor plate on the top of the wobulator base or mount. Substantial alignment of corresponding capacitor plates is desirable. However, some degree of misalignment of the plates can be tolerated. This misalignment can be accounted for by calibrating or “zeroing-out” the relative capacitances upon initial setup (e.g. at the factory). This is particularly true since the output signal will be the difference between the capacitance of the two capacitors, and therefore the absolute values of capacitance of each are not critical.

The circuit diagram of FIG. 14 shows the position sensing circuit 340 for the capacitive wobulator position sensing system 310. This circuit converts a very small change in capacitance into a relatively large voltage signal. The circuit includes four capacitors. As depicted in FIGS. 12 and 14, the capacitors 344 and 346 are the parallel plate capacitors physically located on the wobulator mechanism (the wobulator capacitors), and are designated as variable capacitors. The other two capacitors C3 and C4 (FIG. 14) are tunable capacitors that are part of the position sensing circuit 340. These capacitors can be adjusted initially (e.g. at the factory) when the circuit is first calibrated.

The position sensing circuit 340 includes an AC current source 342 that provides a driving current for all of the capacitors. To measure the change in capacitance as the plates get closer and farther apart, the wobulator capacitors 344 and 346 can be driven at a frequency that is much greater than the frequency of oscillation of the wobulator plate. For example, a 10 KHz squarewave signal can be used to drive the capacitors. Other frequencies and waveforms can also be used.

The capacitors 344, 346, C3 and C4 are connected to an instrumentation amplifier 348 and an Op-Amplifier 350, which produces an AC output voltage signal through output line 352. The output voltage signal is generated by the difference in capacitance between the two wobulator capacitors 344, 346 (not their absolute value), as noted above. This voltage signal can then be used by the wobulator driver circuit (210 in FIG. 10) as feedback for driving the wobulator plate.

The circuit shown in FIG. 14 can be added onto the wobulator driver circuit board, or can be provided on another circuit board closer to the wobulator capacitors. To expand this configuration to support 2-axis wobulation, all that is needed is to add another pair of capacitors (e.g., parallel plates disposed on the wobulator base and a second base, and aligned about a second axis) and another circuit like that shown in FIG. 14.

The circuit shown in FIG. 14 can be configured in other ways as well. While the capacitors 344 and 346 are the wobulator capacitors in FIGS. 12 and 14, other combinations of the four capacitors in the position sensing circuit 340 can be configured as the wobulator capacitors. For example, capacitors C3 and C4 in the circuit could be the wobulator capacitors. It is believed that the combination of 344 and 346 (shown in the figures) or C3 and C4 as the wobulator capacitors will produce the strongest signal. Alternatively, capacitors 344 and C3 or 346 and C4 can be configured as the wobulator capacitors.

This capacitive wobulator position sensor is advantageous in part because it is simple and inexpensive. It only requires four metal plates and associated wires (for one-axis wobulation), and it is a type of technology that has been used in other applications. Additionally, it is easily scalable to a 2-axis wobulator by the addition of 2 more capacitors (4 more metal plates and 4 more wires). It provides “closed loop” control of the wobulator window by giving an analog feedback to the wobulator driver circuit over the entire range of motion.

While the capacitive wobulator position sensing system described above includes two capacitors disposed on the wobulator plate, this type of position sensing system can also be created using only a single capacitor. If one of the capacitors in the configuration illustrated in FIGS. 11 and 12 is eliminated, a single capacitor can still provide the desired wobulator position information through detecting its absolute capacitance. As noted above, the capacitance of the capacitor will change in a known way with change in capacitor plate spacing. Accordingly, given a known geometric position of the parallel plates of the single capacitor with respect to the pivot point, the change in the capacitance will directly indicate a change in spacing. This sort of system will require initial calibration to determine the actual capacitance when the wobulator plate is at certain defined geometric positions (e.g. at the neutral position, max. gap position, and min. gap position), but once calibrated, the system will provide direct output that indicates the capacitor plate spacing, and therefore indicates the degree of tilting of the wobulator plate.

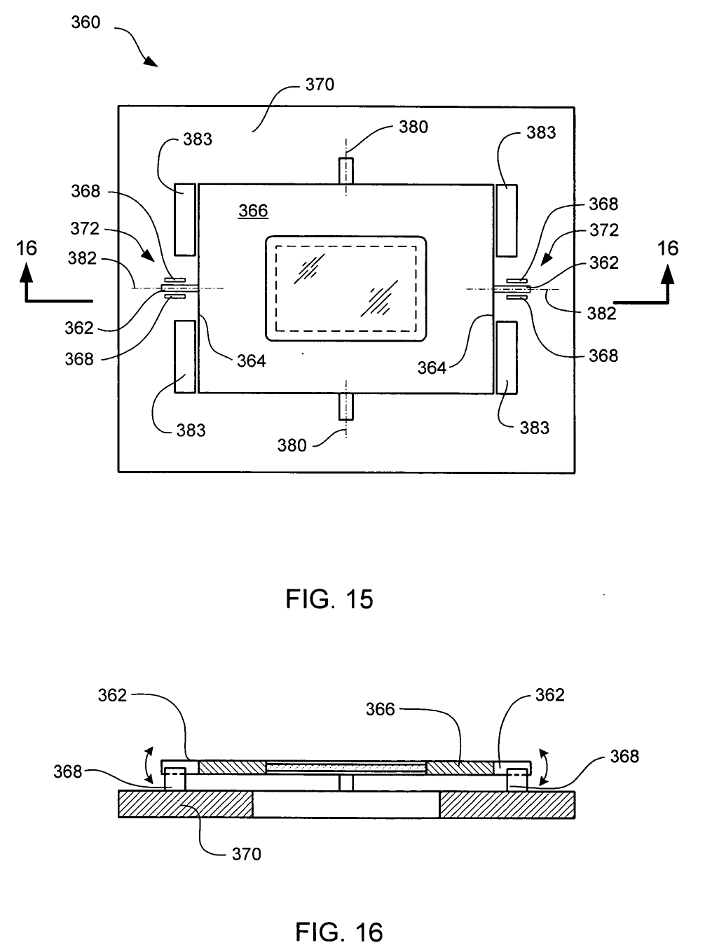

In another embodiment, a variable dielectric capacitive wobulator position sensing system 360 is illustrated in FIGS. 15-18. Rather than having a changing capacitor plate spacing S, this system works by detecting a change in capacitance due to a changing dielectric constant K. In this embodiment, two capacitor assemblies 372 are disposed on opposite sides 364 of the wobulator plate 366. Each capacitor assembly includes an arm 362 of dielectric material extending from the wobulator plate, with two parallel capacitor plates 368 extending upwardly from the wobulator base 370. The capacitor plates partially straddle each dielectric arm. Each capacitor 372 thus has the dielectric material of the dielectric arm (having some characteristic dielectric constant) between a portion of the area of the parallel plates, and an air gap (with a dielectric constant of 1.0) between the remainder of the parallel plate area. Consequently, the net effective dielectric constant for the entire capacitor will be somewhere between the dielectric constant of air, and that of the material of the dielectric arm.

As the wobulator plate 366 tilts, the relative portion of the parallel plate area that is occupied by the dielectric arm 362 changes, thus changing the net dielectric constant of the capacitor 372. Accordingly, the capacitance of each capacitor changes according to the formula C=(8.854E−12*K*A)/S (discussed above), with the dielectric constant K (rather than the capacitor plate spacing S) varying over time. The difference in change in capacitance of the two capacitor assemblies can be used to determine the wobulator plate position in the manner described above and using the circuitry depicted in FIG. 14.

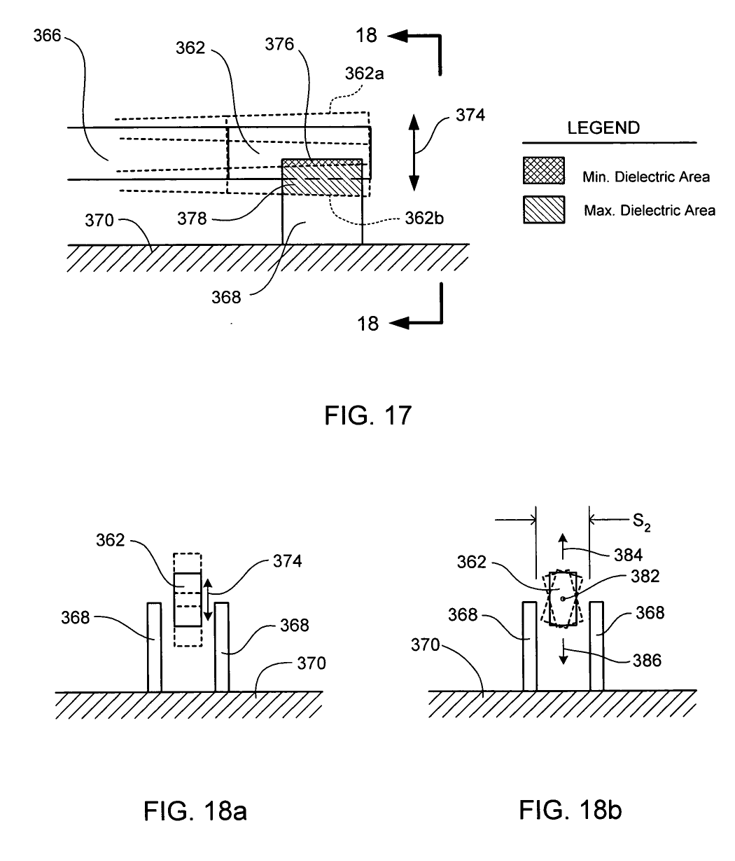

Shown in FIG. 17 is a close-up side view of one of the capacitor assemblies 372 of FIG. 16. The size and shape of the capacitor plates 368 and their position with respect to the dielectric arm 362 is selected so that some portion of the dielectric arm, but not its entirety, is between the capacitor plates 368 during its entire range of motion (represented by arrow 374). This is desirable so that any change of position of the wobulator plate will produce a change in capacitance. It will be apparent that if the dielectric arm entirely leaves the gap between the capacitor plates, its motion outside of that gap will provide no change in capacitance, and thus will not allow position detection. Likewise, if the dielectric arm drops entirely into the gap between the parallel plates, its range of motion while entirely in the gap will not provide a substantial change in capacitance. Consequently, as shown in FIGS. 17 and 18a, the capacitor plates 368 are arranged so that at the upward extremity of the motion of the dielectric arm (represented in dashed lines at 362a), some minimum area 376 of the gap will be covered, and at the lower extremity of the motion of the dielectric arm (represented in dashed lines at 362b) some maximum area 378 of the gap will be covered.

The variable dielectric wobulator position sensing system 360 depicted in FIGS. 15-18 can also be configured using a single capacitor assembly 372 (for single-axis wobulation) in a manner similar to that described above for the variable spacing capacitor configuration. With a single capacitor assembly 372, careful calibration of the wobulator position with the actual capacitance value will allow direct detection of the wobulator position based upon the actual capacitance value. Additionally, it will be apparent that the arrangement of the parts of the variable dielectric wobulator position sensing system can be reversed from that shown. That is, this system can be configured with the capacitor plates 368 attached to the wobulator plate 366, and the arm of dielectric material 362 attached to the wobulator base 370.

The variable dielectric wobulator position sensing system 360 of FIGS. 15-18 is also adaptable to multi-axis wobulation. This can be done by providing additional capacitor assemblies (not shown) on the wobulator base 370 and on a second base similar to the second base 32 shown in FIG. 1. Different mechanical configurations for multi-axis wobulation can also be accommodated, however. As shown in FIG. 15, the capacitor assemblies 372 configured for detecting wobulation about a first axis 380 can be positioned and aligned with a second pivoting axis 382. A second set of capacitor assemblies (not shown) can likewise be positioned and aligned with the first axis 380. With the capacitor assemblies located along the pivoting axes, motor coils 383 to provide a driving motor for the wobulator plate can be located away from the respective pivoting axes, as shown in FIG. 15.

With the wobulator plate 366 simultaneously tilting about the first and second axes 380, 382, each dielectric arm 362 will both move up and down and axially twist within its respective capacitor gap. This condition is shown in FIG. 18b. The spacing S₂ of the capacitor plates 368 can be selected so that the twisting or pivoting of the dielectric arm about the second axis 382 (normal to the plane of the drawing and represented as a point in FIG. 18b) will not cause contact of the dielectric material with the capacitor plates. At the same time, since the axial twisting of the dielectric material is within a relatively small angular range, it will not significantly affect the portion of the capacitor plate gap that is covered by the dielectric material throughout its simultaneous up-down range of motion (indicated by arrows 384, 386 in FIG. 18b).

In comparison with optical wobulator position sensors described above, capacitive wobulator position sensor systems can help avoid some challenges presented by light interactions with the image that is projected at the wobulator. The capacitive position sensing embodiments are less affected by temperature variations than infra-red sensors, and are less affected by ambient light (e.g. from the image beam). Capacitive wobulator position sensors are also relatively easy to manufacture because they do not require precision alignment, and are relatively easily calibrated. These capacitive configurations are also customizable, allowing a user to generate the desired signal level(s) for the wobulator driver board. Additionally, capacitive wobulator position sensors do not require a significant change in the design of the wobulator plate.

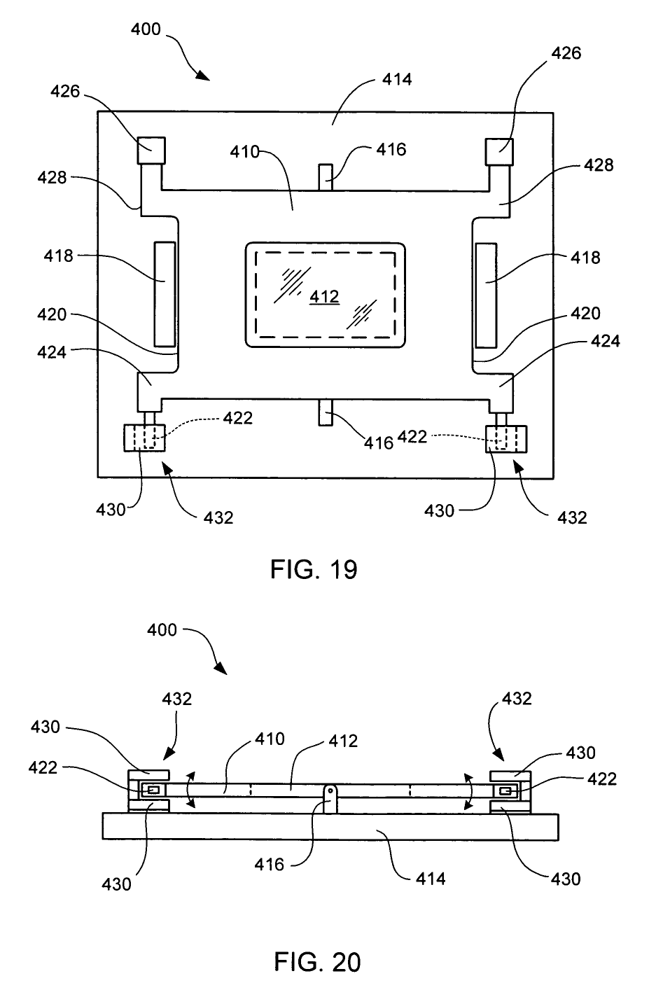

Another type of electronic wobulator position sensing system that can be employed is a Hall Effect wobulator position sensing system 400, depicted in FIGS. 19-20. As with other embodiments, this wobulator system includes a wobulator plate 410 having a wobulator window 412, the wobulator plate being pivotally connected to a wobulator base 414 via pivots 416. Motor coils 418 are disposed adjacent to the free edges 420 of the wobulator plate to provide a driving motor for the wobulator plate.

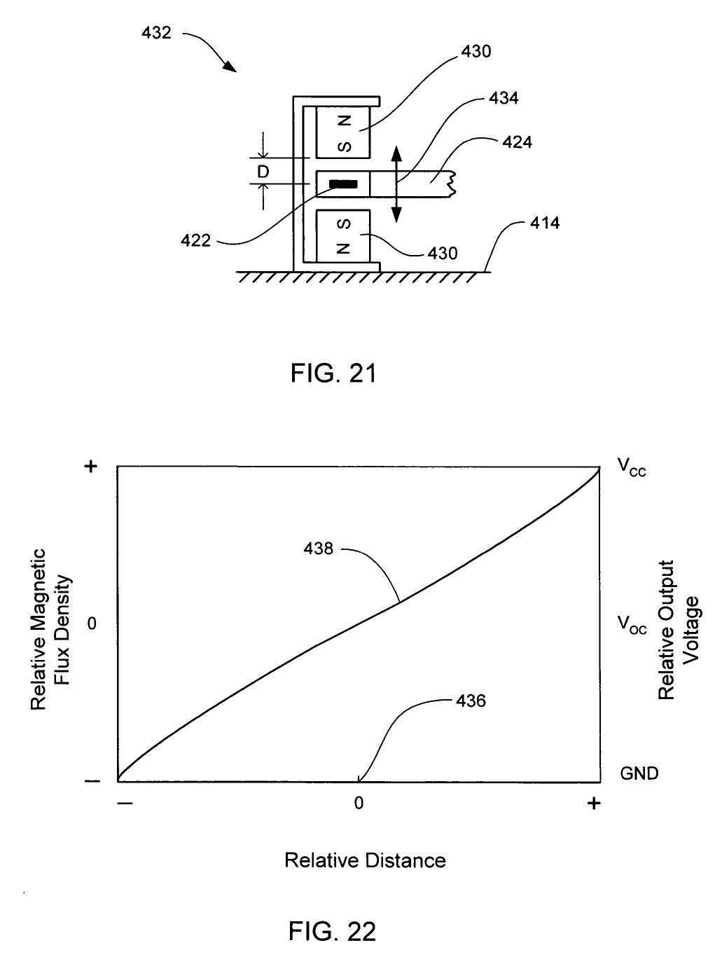

The Hall Effect wobulator position sensing system 400 employs one or more Hall Effect sensors 422 that are mounted to arms 424 extending from opposite sides of the wobulator plate 410. Counterweights 426 can be provided on arms 428 extending from the opposite sides of the wobulator plate, to provide balance and reduce vibration. The Hall Effect sensors are configured to oscillate with the motion of the wobulator plate between aligned pairs of permanent magnets 430, to determine the position of the wobulator window using the Hall Effect. A detail view of one magnet/sensor assembly 432 is provided in FIG. 21. The permanent magnets are arranged with like poles facing. The Hall Effect sensor moves up and down between the two magnets (in the direction of arrow 434) as the wobulator plate tilts back and forth.

A graph of magnetic flux density and output voltage with respect to relative distance D of the Hall Effect Sensor 422 between the two magnets 430 is provided in FIG. 22. In this graph, the zero point 436 on the horizontal axis represents the sensor in a middle position between the two magnets (i.e. with the wobulator plate 410 in the neutral position). By using a pair of magnets with like poles facing, this sensor configuration provides a nearly linear output voltage curve 438, as shown by the graph.

With proper calibration, including determining the output voltage when the wobulator plate is at the neutral position, the Hall Effect wobulator position sensor system can be configured with a single Hall Effect sensor and magnet assembly. That is, the almost linear variation in output voltage of the Hall Effect sensor can be directly detected and, combined with the known geometry of the wobulator plate, can be converted into a value representing the degree of tilting of the wobulator plate.

In order to increase the sensitivity of the system and to cancel out a possible “trampoline” effect of the wobulator plate, a system of two sensors can also be used, as depicted in FIGS. 19-20. In the two-sensor configuration, there are identical magnet/sensor assemblies 432 on two opposite sides of the wobulator plate 410, located at the corners. The difference between the outputs of the two sensor assemblies is used as the position signal, and is provided as feedback to the wobulator driver.

Like the capacitive system, the Hall Effect sensor configuration provides a simple and low cost wobulator position sensing system that is insensitive to ambient light and light noise. Additionally, since Hall Effect sensors and magnets are mature technologies, this system can be configured from non-custom parts. It will also be apparent that the configuration of the Hall Effect sensor and the permanent magnets can be reversed, with the permanent magnet pair attached to the wobulator plate, and the Hall Effect sensor attached to the wobulator base.

The various embodiments disclosed herein provide a simple and robust system for sensing the position or angular shift of a wobulator plate, either refractive or reflective, using an electrical or electro-optical system. In its various embodiments, the wobulator position sensing system provides accurate feedback, while also tolerating variations in the relative positioning of components. Without the need for extremely high precision, projection systems can have a simpler design and lower cost while still providing high quality images. This allows projection systems incorporating wobulation technology to provide higher resolution without the need for a greater number of pixels or higher pixel density.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A wobulator position sensing system, comprising:
a wobulator plate, including a wobulator window, disposed along an image projection path, configured to selectively tilt so as to shift the projection path; and
a position detector, associated with the wobulator plate, configured to sense a magnitude of tilting of the wobulator plate, and to produce a feedback signal useable to control tilting of the wobulator plate.

2. A wobulator position sensing system in accordance with claim 1 wherein the position detector comprises:
a light source, configured to produce a sense beam of light, aimed at the wobulator window; and
a photodetector, configured to receive the sense beam after contact with the wobulator window, and to detect a shift of position of incidence of the sense beam thereupon due to the tilt of the wobulator.

3. A wobulator position sensing system in accordance with claim 2, wherein the wobulator window is substantially transparent, and the sense beam is configured to pass through the wobulator window prior to contacting the photodetector.

4. A wobulator position sensing system in accordance with claim 2, wherein the wobulator window includes a reflective portion, and the sense beam is configured to reflect from the reflective portion prior to contacting the photodetector.

5. A wobulator position sensing system in accordance with claim 4, further comprising a collection lens, disposed adjacent to the photodetector, configured to focus the beam of light upon the photodetector, the collection lens having a size selected to allow collection of the beam of light throughout a range of lateral translation positions.

6. A wobulator position sensing system in accordance with claim 2, wherein the photodetector comprises a lateral effect photodiode, configured to detect a relative location of contact of the beam of light upon a single photosensitive surface, and to provide a position signal corresponding to the location of contact.

7. A wobulator position sensing system in accordance with claim 2, wherein the light source is selected from the group consisting of an infrared LED, and an infrared laser.

8. A wobulator position sensing system in accordance with claim 1, wherein the position detector comprises a capacitive sensor system, inclulding:
a wobulator base, supporting the wobulator plate;
a capacitor, mechanically coupled to the wobulator plate and to the wobulator base, the geometry of the capacitor configured to vary as the wobulator plate tilts with respect to the wobulator base; and
a detection circuit, coupled to the capacitor, configured to detect a change in capacitance of the capacitor as its geometry changes.

9. A wobulator position sensing system in accordance with claim 8, wherein the capacitor comprises:
a first capacitor plate disposed upon the wobulator plate; and
a second capacitor plate oppositely disposed upon the wobulator base, such that a distance between the first and second capacitor plates changes with tilting of the wobulator plate, thereby changing the capacitance of the capacitor.

10. A wobulator position sensing system in accordance with claim 9, further comprising a second capacitor, having a third capacitor plate disposed upon the wobulator plate, and a fourth capacitor plate oppositely disposed upon the wobulator base, such that a distance between the third and fourth capacitor plates changes with tilting of the wobulator plate, the detection circuit being configured to detect the magnitude of tilting of the wobulator plate by measuring a difference in capacitance of the capacitor and the second capacitor.

11. A wobulator position sensing system in accordance with claim 8, wherein the capacitor comprises:
an arm of dielectric material, extending from the wobulator plate; and
a pair of parallel capacitor plates, extending from the wobulator base and partially straddling the arm of dielectric material, such that a relative portion of dielectric material between the capacitor plates changes as the wobulator plate tilts, thereby changing the capacitance of the capacitor.

12. A wobulator position sensing system in accordance with claim 11, further comprising:
a second capacitor, having a second arm of dielectric material extending from a side of the wobulator plate opposite a position of the aforesaid arm of dielectric material;
a second pair of parallel capacitor plates, extending from the wobulator base and partially straddling the second arm of dielectric material, such that a relative portion of the second arm of dielectric material between the second pair of capacitor plates changes as the wobulator plate tilts, thereby changing the capacitance of the second capacitor, the detection circuit being configured to detect the magnitude of tilting of the wobulator plate by measuring a difference in capacitance of the capacitor and the second capacitor.

13. A wobulator position sensing system in accordance with claim 1, wherein the position detector comprises a Hall Effect sensor system, including:
a first pair of permanent magnets, having like magnetic poles facing each other, and defining a first gap therebetween; and
a first Hall Effect sensor, attached to the wobulator plate and disposed in the first gap, configured to oscillate between the pair permanent magnets with tilting of the wobulator, and to produce an output voltage indicative of the magnitude of tilting of the wobulator plate.

14. A wobulator position sensing system in accordance with claim 13, further comprising:
a second pair of permanent magnets, having like magnetic poles facing each other, and defining a second gap therebetween; and
a second Hall Effect sensor, attached to the wobulator plate and disposed in the second gap, configured to oscillate between the pair permanent magnets with tilting of the wobulator.

15. A wobulator position sensing system in accordance with claim 14, further comprising a detection circuit, configured to detect the magnitude and a direction of tilting of the wobulator plate by comparing a relative difference in magnitude and polarity of an output voltage of the first and second Hall Effect sensors.

16. A wobulator position sensing system, comprising:
a wobulator base;
a wobulator, tiltably disposed on the wobulator base, including a wobulator plate and a wobulator window, disposed in an image projection path, configured to selectively tilt so as to shift the projection path;
a wobulator driving circuit, configured to control tilting of the wobulator plate; and
means for sensing a magnitude of tilt of the wobulator plate, and for providing a feedback signal indicating to the wobulator driving circuit the magnitude of tilt.

17. A wobulator position sensing system in accordance with claim 16, wherein the means for sensing is selected from the group consisting of electronic sensor systems and optical sensor systems.

18. A wobulator position sensing system in accordance with claim 17, wherein the optical sensor system comprises:
a light source, configured to produce a beam of light, aimed at the wobulator window; and
a photodetector, configured to receive the beam of light after contact with the wobulator window, and to detect a shift of position of incidence of the light beam thereupon due to tilt of the wobulator plate.

19. A wobulator position sensing system in accordance with claim 18, wherein the wobulator window is substantially transparent, and the light source is disposed on a first side of the wobulator window, the photodetector is disposed on a second side of the wobulator window, and the beam of light is configured to pass through the wobulator window and to be refracted thereby in response to the tilt of the wobulator plate.

20. A wobulator position sensing system in accordance with claim 18, wherein the light source and photodetector are disposed on a first side of the wobulator, and the beam of light is configured to reflect from a reflective surface of the wobulator window, such that the position of incidence of the reflected light beam upon the photodetector shifts in response to the tilt of the wobulator.

21. A wobulator position sensing system in accordance with claim 17, wherein the electronic sensor system comprises a capacitive sensor system, including:
a pair of capacitors, associated with the wobulator plate and the wobulator base and disposed at opposite sides thereof, the geometry of each capacitor and a capacitance thereof changing with tilting of the wobulator plate; and
a detection circuit, configured to detect tilting of the wobulator by measuring a relative difference in capacitance of the pair of capacitors.

22. A wobulator position sensing system in accordance with claim 17, wherein the electronic sensor system comprises a Hall Effect sensor system, including:
a pair of permanent magnet pairs, associated with the wobulator plate and the wobulator base and disposed at opposite sides thereof, each pair of permanent magnets having like magnetic poles facing each other, and defining a gap therebetween; and
a pair of Hall Effect sensors, associated with the wobulator plate and the wobulator base and disposed in the gap between magnets of a respective permanent magnet pair, the position of the Hall Effect sensors between the permanent magnets being configured to change with tilting of the wobulator, and to produce an output voltage indicative of the magnitude of tilting of the wobulator plate.

23. An image projection system, comprising:
a spatial light modulator, configured to project an image along an image projection path;
a wobulator, having a wobulator window, disposed in the image projection path, configured to selectively tilt so as to shift the projection path;
a non-contact position detector, configured to sense a magnitude of tilt of the wobulator without mechanically contacting the wobulator, and to produce a feedback signal useable to control tilting of the wobulator.

24. An image projection system in accordance with claim 23, wherein the non-contact position detector is selected from the group consisting of electronic sensor systems and optical sensor systems.

25. An image projection system in accordance with claim 24, wherein the electronic sensor system is selected from the group consisting of a capacitive sensor system and a Hall Effect sensor system.

26. An image projection system in accordance with claim 24, wherein the optical sensor system comprises:
a light source, configured to produce a beam of light, aimed at the wobulator window; and
a photodetector, configured to receive the beam of light after contact with the wobulator, and to detect a shift of position of incidence of the light beam thereupon due to tilt of the wobulator.

27. A method for projecting an image, comprising the steps of:
projecting an image along a projection path;
tilting a wobulator disposed in the projection path so as to shift the projection path;
sensing a degree of tilting of the wobulator.

28. A method in accordance with claim 28, wherein the step of sensing a degree of tilting of the wobulator comprises:
projecting a sense beam at a window of the wobulator;
causing the sense beam to contact the wobulator window; and
detecting a position of incidence of the sense beam upon a photodetector after the sense beam has contacted the wobulator window.

29. A method in accordance with claim 28, wherein the step of sensing a degree of tilting of the wobulator comprises detecting capacitance of at least one capacitor having geometry that changes as the wobulator tilts.

30. A method in accordance with claim 28, wherein the step of sensing a degree of tilting of the wobulator comprises detecting an output voltage of a Hall Effect sensor attached to the wobulator and configured to oscillate, with tilting of the wobulator, between a pair of permanent magnets having like poles facing each other.
